(19) United States
(12) Patent Application Publication
(10) Pub. No.: US 2022/0048113 A1
(43) Pub. Date: Feb. 17, 2022

(54) HEAT SOURCE CALIBRATION

(71) Applicant: Hewlett-Packard Development Company, L.P., Spring, TX (US)

(72) Inventors: Daniel Pablo Rosenblatt, Sant Cugat del Valles (ES); Marc Borras Camarasa, Sant Cugat del Valles (ES); Hector Vega Ponce, Sant Cugat del Valles (ES)

(73) Assignee: Hewlett-Packard Development Company, L.P., Spring, TX (US)

(21) Appl. No.: 17/414,107

(22) PCT Filed: Apr. 30, 2019
(86) PCT No.: PCT/US2019/030045

§ 371 Date: Jun. 15, 2021

(51) Int. Cl. B22F 10/31; B22F 10/85; B22F 12/53; B22F 12/90; B22F 10/14; B33Y 10/00; B33Y 30/00; B33Y 50/02

(52) U.S. Cl. CPC B22F 10/31; B22F 10/85; B22F 12/53; B22F 12/90; B22F 2203/11; B33Y 10/00; B33Y 30/00; B33Y 50/02; B22F 10/14

(57) ABSTRACT

An example three-dimensional printer includes a print agent distributor to provide a printing agent to a print bed of powdered build material, a heat source to apply heat over the print bed to form a printed part where printing agent is applied, a heat sensor to measure a temperature of the printed part after heat has been applied, and a processor coupled to the heat sensor. The processor is to determine a target power to be applied to the heat source heat a part to a target temperature in a subsequent printing process. The processor is to determine the target power based on the target temperature, a measured first temperature of a first printed part formed when a first power is applied to the heat source and a measured second temperature of a second printed part formed when a second, different power is applied to the heat source.

### BACKGROUND

A three-dimensional printer may generate a three-dimensional object by printing a series of two-dimensional layers on top of one another. In some three-dimensional printing systems, each layer of an object may be formed by placing a uniform layer of build material on a build bed of a printer, and placing liquid printing agents at the specific points at which it is desired to solidify the build material to form the layer of the object. A fusing lamp may then apply energy to the layer of build material, to cause the build material to solidify in accordance with where printing agents were applied.

### BRIEF DESCRIPTION OF THE DRAWINGS

FIG. 1 is an illustration of an example three-dimensional printer;

FIG. 2 is a flow chart of an example heat source calibration method;

FIG. 3 is an illustration of an example calibration plot;

FIG. 4 is an illustration of a graphical representation of part temperature for heat source calibration; and

FIG. 5 is a block diagram of an example of a machine readable medium in association with a processor.

### DETAILED DESCRIPTION

In three-dimensional printing, also referred to as additive manufacturing, a layer of a three-dimensional object may be generated by solidifying a portion of build material to which a printing agent has been applied. The build material may be a powder or powder-like material. In some examples, the build material may be a short fibre build material. In some examples, the powder may be formed from, or may include, short fibres that may, for example, have been cut from long strands or threads of material. The powder or powder-like material may be a plastics powder, a ceramic powder or a metal powder.

The process of generating a layer may be referred to as a printing cycle, and the printing cycle may be repeated several times to form a plurality of successive layers, thereby generating the three-dimensional object.

In an example, a first stage of the printing cycle may comprise providing a layer of powdered build material; a subsequent stage of the printing cycle may comprise distributing a fusing agent over the layer of powdered build material in a predetermined pattern; a subsequent stage of the printing cycle may comprise applying energy over the print bed so that portions of the powder on which fusing agent is applied heat up and coalesce. In a final stage of the printing, the print bed cools and the portions of the powder to which the fusing agent has been applied solidify, thereby forming a layer of the object.

In another example, a first stage of the printing cycle may comprise providing a layer of powdered metal build material; a subsequent stage may comprise distributing a binding agent over the layer of powdered metal build material in a predetermined pattern to solidify the portions of powder to which the binding agent is applied: a subsequent stage of the printing cycle may comprise applying energy over the print bed to cure the solidified portions of powder. In a final stage of the printing cycle, the print bed including the solidified layer cools.

A plurality of factors can affect the temperature of the printed part after the heat source has applied energy to the print bed. These factors may include the power of the heat source, the transparency of protective glass provided between the heat source and the print bed, the amount of printing agent used and the cooling process within the build unit.

Examples described herein allow the heat source to be controlled such that the temperature of printed parts can be uniform across a plurality of three-dimensional printers at a corresponding time in the printing cycle. This may be achieved by calibrating the heat source in order to obtain a predetermined temperature at a certain stage of the printing cycle, Controlling the temperature of the printed parts may prevent cosmetic defects (for example thermal bleeding) and may improve dimensional uniformity and mechanical properties uniformity in parts printed from different three-dimensional printers.

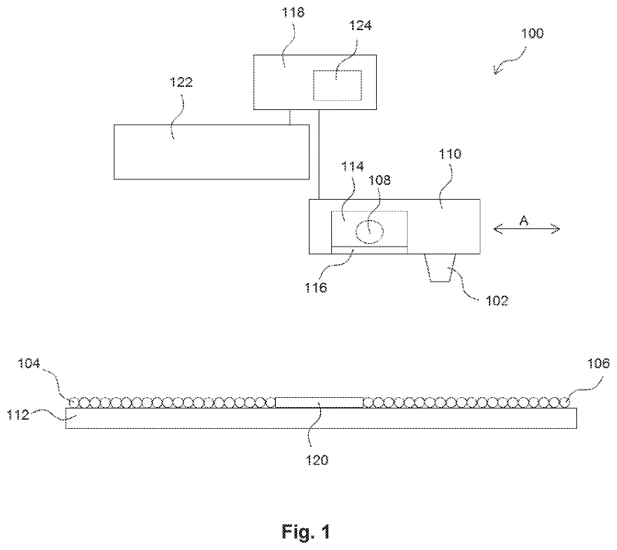

FIG. 1 shows an example of a three-dimensional printer 100. The three-dimensional printer 100 comprises a print agent distributor 102 configured to provide a printing agent to a print bed 104 of powdered build material 106. In an example, the printing agent may be a fusing agent. In an example, the printing agent may be a binding agent. The print agent distributor 102 may be a printhead, for example a thermal or piezo printhead. The printhead may comprise a nozzle, for example an array of nozzles. The three-dimensional printer 100 comprises a heat source 106 configured to apply heat over the print bed 104. The print agent distributor 102 and heat source 108 may be provided on a carriage 110 that may be may be configured to move over the print bed 104, in a direction indicated by arrow A.

The three-dimensional printer 100 may be configured to receive a build unit. The build unit may comprise a build platform 112 on which the print bed 104 of powdered build material may be formed and a powder supply unit (not shown) configured to provide a layer of the powdered build material on the build platform 112 to form the print bed 104. The build unit may be removable from the three-dimensional printer. In another example, the three-dimensional printer may comprise the build unit, and the build unit may be fixed in the three-dimensional printer. The powdered build material 106 may be a thermoplastic powder that can coalesce and solidify upon application of a fusing agent and energy.

The heat source 108 may be a lamp, for example a fusing lamp, an infrared lamp or a microwave lamp. In some examples, the three-dimensional printer 100 may comprise a plurality of lamps. The heat source 108 may be provided in a heat source enclosure 114 within the carriage 110. A window 116 may be provided in the heat enclosure 114 through which energy from the heat source 108 may travel towards the print bed 104. The three-dimensional printer 100 may comprise a control unit 118 that may be configured to control the amount of power supplied to the heat source 108, for example the amount of power supplied to each lamp.

In an example, in use, the powder supply unit may provide a layer of powder 106 on the build platform 112 to form a print bed 104. The carriage 110 may move over the print bed 104 and the print agent distributor 102 may deposit fusing agent to portions of the powder 106. The heat source 108 may heat up the print bed 104 so that the portions of the powder 106 to which the fusing agent has been deposited heat up and coalesce. These portions of the powder may then cool to form a solidified printed part 120.

In some examples, in use, the print agent distributor may deposit binding agent to portions of the powder, to solidify the portions of the powder to which the binding agent has been applied. The heat source may heat up the print bed so that the solidified portions are cured. The solidified portions may then cool to form a solidified printed part

In a process for printing three-dimensional objects, the printed part 120 may be a layer of a plurality of layers that are formed to generate the three-dimensional object.

The three-dimensional printer comprises a heat sensor 122 configured to measure a temperature of the printed part 120 after heat has been applied by the heat source 108. The heat sensor 122 may be a thermal imaging device, for example a thermal camera, configured to capture thermal images. The thermal camera may be provided above the print bed 104, for example above the carriage 110.

The three-dimensional printer 100 comprises a processor 124 coupled to the heat sensor 122. The processor 124 is configured to determine a target power to be applied to the heat source 108 to enable a subsequent printed part to be heated by the heat source 108 to a target temperature. The processor 124 is configured to determine the target power based on the target temperature, a measured first temperature of a first printed part formed when a first power is applied to the heat source and a measured second temperature of a second printed pail formed when a second power is applied to the heat source 108, wherein the second power is different to the first power. The processor 124 may be part of the control unit 118. The control unit 118 may be configured to control the power supplied to the heat source based on the target power determined by the processor 124.

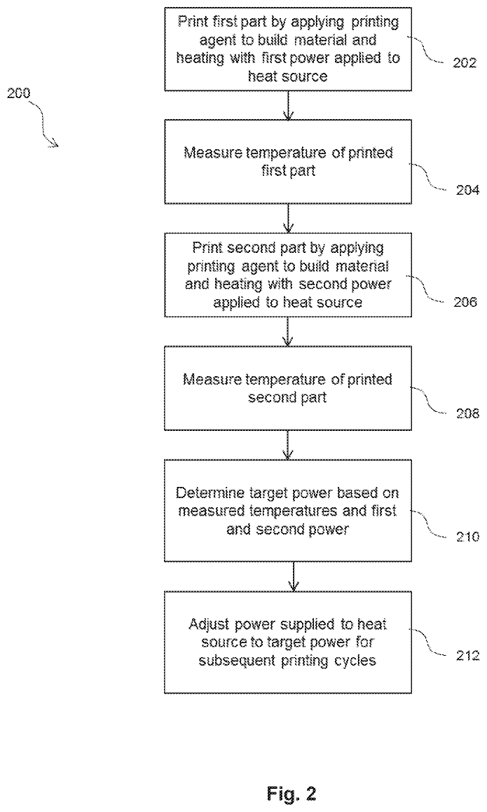

FIG. 2 is a flowchart of an example method 200 of calibrating a heat source. The method may be executable by the three-dimensional printer 100 as shown in FIG. 1. In some examples, the method can be utilized for each of a plurality of three-dimensional printers, to provide uniformity of printed objects between the plurality of three-dimensional printers.

The method comprises, in block 202, printing a first part by applying a printing agent to a region of build material on a print bed and heating the print bed by supplying a first power to a heat source. The heat source may heat up the regions of the print bed to which the printing agent has been applied, causing the build material to coalesce. These regions of the build material may then solidify as they cool, upon removal of the heat to the print bed. In some examples, the heat source may cure the regions of the print bed to which the printing agent has been applied.

The power applied to the heat source may be electrical power, in watts. In other examples, the power applied to the heat source may refer to other ways in which the heat source is actuated, such as voltage in volts or irradiance in watts per square meter.

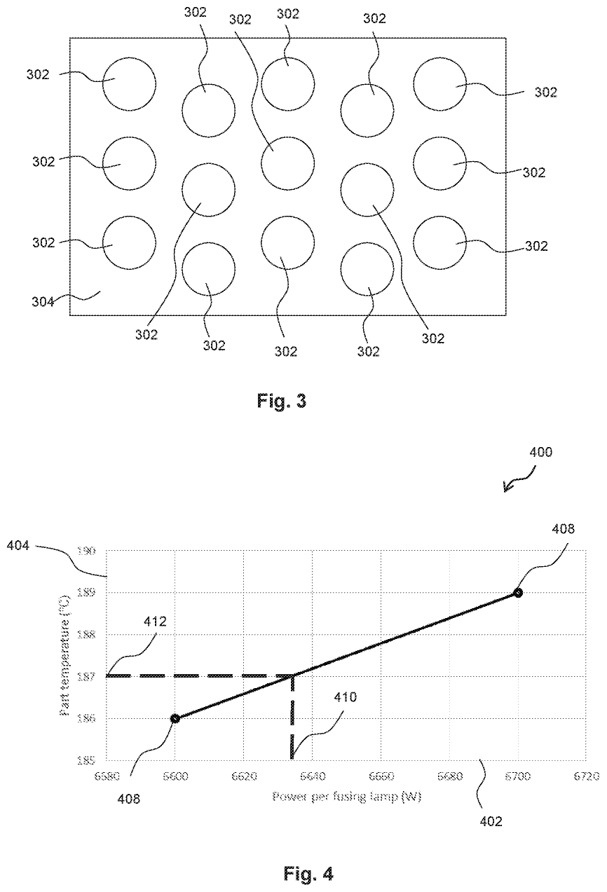

In printing the first part, a calibration plot may be generated by printing a plurality of parts 302. The plurality of parts 302 may be spaced apart across the print bed 304, as shown in FIG. 3. The plurality of printed parts 302 may be disc-shaped parts. In other examples, the plurality of printed parts 302 may take different shapes.

Returning to FIG. 2. the temperature of the printed first part is measured, in block 204. Measuring the temperature of the printed first part may comprise measuring the temperature of each of the printed parts in the calibration plot. An average temperature may be calculated based on the temperatures of each of the printed parts in the calibration plot.

The heat sensor may be a thermal camera. The plurality of the printed parts may each correspond to one or more pixels of the thermal camera. The size of each of the printed parts may therefore depend on the resolution of the thermal camera.

The temperature of the printed parts may change over time, in the printing cycle. The heat sensor may measure the temperature at one or more points in the printing cycle. In some examples, the heat sensor may measure the temperature at a time in the printing cycle immediately before a next layer of powdered build material is applied to the build bed. At this stage, the temperature of the printed part may be more stable than immediately after the energy is applied by the heat source, when the temperature may be falling rapidly. The measured temperature may thereby be more reliable. Additionally, at this stage the print agent distributor and heat source, which may be provided on a carriage, may have moved away from the field of view of the thermal camera.

Measuring the temperature of the printed part may be more reliable than measuring the temperature of the powder bed after heating. This is because the powder may be more prone to oxidation, contamination and variability between batches and the powder may be sensitive to ambient temperature and humidity. These variations can cause changes in thermal emissivity, thermal capacity, density and/or reflectance of the powder. In addition, reflected energy may be accounted for in the part temperature.

After a predetermined amount of time, in which the printed part cools, a layer of powdered build material may be provided on top of the previous layer on the print bed. A second part is printed by applying printing agent to a region of build material on the print bed and heating the print bed by applying a second power to a heat source, in block 206. The method may comprise adjusting the power supplied to the heat source to the value of the second power. The value of the second power may be different to the value of the first power, and may be higher or lower than the first power.

Printing the second printed part may comprise printing a plurality of printed parts across the print bed, forming a calibration plot. Printing the second part may comprise applying printing agent to the region of build material corresponding to the first printed part. The second printed part may thereby be printed on top of the first printed part, so that the first printed part forms a first layer of a three-dimensional object and the second printed part forms a second layer of the three-dimensional object.

The temperature of the printed second part is measured, in block 208. The temperature of the printed second part may be measured at a time in the printing cycle corresponding to the time at which the temperature of the printed first part was measured.

The target power to be applied to the heat source to achieve a target temperature of a subsequent printed part is determined based on the measured temperatures and the first and second power, in block 210. The power supplied to the heat source may be adjusted to the target power for subsequent printing cycles, in block 212.

The target power may be determined by determining a relationship between part temperature and the power applied to the heat source. For example, the target power may be determined by linear interpolation, as shown in the graphical representation 400 in FIG. 4. In other examples, the target power may be determined by linear extrapolation.

As shown in FIG. 4, in an example, a graphical representation 400 may include an x-axis 402 representing power applied to the heat source, for example power supplied to each fusing lamp, and a y-axis 404 representing the temperature of a printed part. A first measurement point 406 may correspond to the measured first temperature when the first power was applied, to generate the first part according to the method in block 202 of FIG. 2. A second measurement point 408 may correspond to the measured second temperature when the second power was applied, to generate the second part according to the method in block 206 of FIG. 2. A straight line may be determined joining first and second measurement points 406, 408 to determine the relationship between power and temperature. The target power 410 to be applied to the heat source to achieve the target temperature 412 in a printed part at the time in the printing cycle corresponding to the time at which the first and second temperature measurements were taken may be determined based on the determined relationship between supplied power and part temperature.

The target temperature may be a predetermined temperature. The target temperature may depend on the printing mode of the three-dimensional printer. The target temperature may be a temperature at which defects of the printed object are prevented. The target temperature may be a predetermined temperature for a specific print mode. The printer may be configured to print in a plurality of different print modes. In an example, the printing of the first part and the second part may comprise printing in a set print mode from among the plurality of print modes. The method may comprise associating the determined target power with a specific print mode. The method may comprise storing the determined target power in a memory.

In an example, the method 200 shown in FIG. 2 may be performed in different print modes. In an example, the method may be repeated for different print modes, to determine different target power values for a plurality of different print modes.

The method 200 shown in FIG. 2 may be a calibration method and may be performed independently of a printing process for printing a three-dimensional object. The calibration method may be performed periodically, for example weekly or monthly. The frequency of performance of the calibration method may depend on the rate of degradation of the lamps, or other parts of the three-dimensional printer.

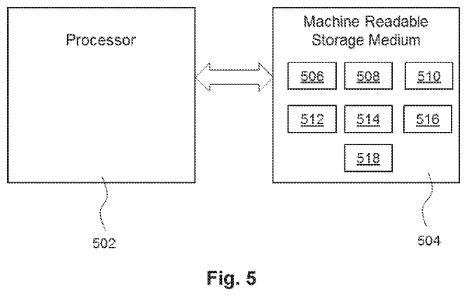

Various elements and methods described herein may be implemented through the execution of machine-readable instructions by a processor. FIG. 5 shows a processing system comprising a processor 502 in association with a non-transitory machine-readable storage medium 504. The machine-readable storage medium may be a tangible storage medium such as a removable storage unit or a hard disk installed in a hard disk drive. The machine-readable storage medium 504 comprises instructions at box 506 to apply a first power to a heat source to heat a print bed and form a first printed part, instructions at box 508 to measure a temperature of the first printed part; instructions at box 510 to apply a second power to a heat source to heat a print bed and form a second printed part; instructions at box 512 to measure a temperature of the second printed part; instructions at box 514 to determine a relationship between a power applied to the heat source and a measured temperature of a printed part based on the measured temperatures; and instructions at box 516 to determine a target power to achieve a target temperature of a printed part based on the determined relationship.

The machine-readable storage medium 504 may comprise instructions at box 518 to set a power applied to the heat source to he the determined target power.

The instructions to measure a temperature of a first printed part may comprise instructions to measure the temperature at a predetermined first time and the instructions to measure the temperature of the second printed second part may comprise instructions to measure the temperature at a predetermined second time. The first and second times may be at a corresponding stage of a printing cycle, for example immediately prior to a next layer of build material being applied to the print bed.

According to examples described herein, a heat source may be calibrated such that the temperature of a printed part at a predetermined stage of the printing cycle is at a target temperature. This may improve uniformity between parts printed by different three-dimensional printers, and may prevent surface defects in the printed parts. Measuring a temperature of a printed part in a calibration method may improve reliability of the calibration.

1. A three-dimensional printer comprising:
a print agent distributor configured to provide a printing agent to a print bed of powdered build material;
a heat source configured to apply heat over the print bed to form a printed part at a region of the print bed to which printing agent is applied;
a heat sensor configured to measure a temperature of the printed part after heat has been applied by the heat source; and
a processor coupled to the heat sensor, wherein the processor is configured to determine a target power to be applied to the heat source to enable a part to be heated by the heat source to a target temperature in a subsequent printing process,
wherein the processor is configured to determine the target power based on the target temperature, a measured first temperature of a first printed part formed when a first power is applied to the heat source and a measured second temperature of a second printed part formed when a second power is applied to the heat source, wherein the second power is different to the first power.

2. A three-dimensional printer in accordance with claim 1, wherein the printer is configured to form printed parts in a plurality of different print modes, and wherein, when the first printed part and the second printed part are printed in a first print mode of the plurality of print modes, the processor is configured to associate the determined target power to the first print mode.

3. A three-dimensional printer in accordance with claim 1, wherein the processor is configured to adjust a power applied to the heat source to the target power for subsequent printing.

4. A three-dimensional printer in accordance with claim 1, wherein the print agent distributor is configured to provide the printing agent to a plurality of regions of the print bed to form a plurality of first printed parts, and wherein the heat sensor is configured to measure the temperature of the plurality of first printed parts.

5. A three-dimensional printer in accordance with claim 4, wherein the heat sensor comprises a thermal camera, and wherein each of the first printed parts has a predetermined size, corresponding to two or more pixels of the thermal camera.

6. A method comprising:
printing a first part by applying a printing agent to a region of build material on a print bed and heating the print bed by applying a first power to a heat source;
measuring a temperature of the printed first pail:
printing a second pail by applying a printing agent to a region of build material on the print bed and heating the print bed by applying a second power to the heat source;
measuring a temperature of the printed second part;
determining a target power to be applied to the heat source to achieve a target temperature of a subsequent printed part based on the measured temperatures and the first and second power.

7. A method in accordance with the method of claim 7, further comprising adjusting a power supplied to the heat source to the target power for subsequent printing cycles.

8. A method in accordance with the method of claim 6, wherein determining the power of the heat source to be applied to achieve the target temperature comprises determining a relationship between the power of the heat source and the temperature of the printed part using the first and second power and measured temperatures of the first and second parts.

9. A method in accordance with the method of claim 6, wherein measuring the temperature of the first printed layer and measuring the temperature of the second printed layer comprises measuring the temperatures at a corresponding predetermined time in a printing cycle.

10. A method in accordance with the method of claim 9, wherein the predetermined time in the printing cycle is prior to a subsequent layer of build material being provided on the print bed.

11. A method in accordance with the method of claim 6, wherein printing the first layer comprises providing printing agent to a plurality of regions of build material on the print bed to form a calibration plot having a plurality of printed parts and measuring the temperature of the printed first layer comprises measuring a temperature of each of the printed parts on the calibration plot; and wherein printing the second layer comprises providing printing agent to a plurality of regions of build material on the print bed corresponding to the calibration plot and measuring the temperature of the printed second layer comprises measuring a temperature of each of the printed pails on the calibration plot.

12. A non-transitory machine-readable storage medium encoded with instructions executable by a processor, the machine-readable storage medium comprising:
instructions to apply a first power to a heat source to heat a print bed and form a first printed part,
instructions to measure a temperature of the first printed part;
instructions to apply a second power to a heat source to heat a print bed and form a second printed part,
instructions to measure a temperature of the second printed part;
instructions to determine a relationship between a power of the heating lamp and a measured temperature of a printed part based on the measured temperatures;
instructions to determine a target power to achieve a target temperature of a printed part based on the determined relationship.

13. A non-transitory machine-readable storage medium in accordance with claim 12, comprising instructions to set a power applied to the heat source to the determined target power.

14. A non-transitory machine-readable storage medium in accordance with claim 12, wherein the instructions to measure a temperature of a first printed part comprise instructions to measure the temperature at a predetermined first time and the instructions to measure the temperature of the second printed second part comprise instructions to measure the temperature at a predetermined second time;
wherein the first time and second time are at a corresponding stage of a printing cycle.

15. A non-transitory machine-readable storage medium in accordance with claim 14, wherein the stage of the printing cycle at which the temperature of the first printed part is measured and the temperature of a second printed part is measured is immediately prior to build material being applied to the print bed.
